(19) United States
(12) Patent Application Publication
(10) Pub. No.: US 2024/0107257 A1
(43) Pub. Date: Mar. 28, 2024

(54) RELOCATION OF SOUND COMPONENTS IN SPATIAL AUDIO CONTENT

(71) Applicant: Apple Inc., Cupertino, CA (US)

(72) Inventors: Anna L. Brewer, Santa Barbara, CA (US); Elena J. Nattinger, Menlo Park, CA (US); Devin w. Chalmers, Oakland, CA (US)

(21) Appl. No.: 18/370,764

(22) Filed: Sep. 20, 2023

Related U.S. Application Data
(60) Provisional application No. 63/409,570, filed on Sep. 23, 2022.

(51) Int. Cl. H04S 7/00

(52) U.S. Cl. CPC H04S 7/304

(57) ABSTRACT

One or more sound components are identified, isolated, and processed such that they are relocated to a different location in a sound field of spatial audio content. The one or more sounds may be voices, and in particular voices of a predetermined user.

### CROSS-REFERENCE TO RELATED APPLICATION(S)

This application is a nonprovisional patent application of and claims the benefit of U.S. Provisional Patent Application No. 63/409,570, filed Sep. 23, 2022 and titled “Relocation of Sound Components in Spatial Audio Content,” the disclosure of which is hereby incorporated herein by reference in its entirety.

### TECHNICAL FIELD

Embodiments described herein relate to spatially rendering audio, and in particular to systems and methods for relocating sound components in a sound field of spatial audio content to improve user experience.

### BACKGROUND

Spatial audio content provides an immersive listening experience by simulating sounds originating at particular locations with respect to a listener, so that the distribution of sounds more closely approximates that of an original recording environment of the spatial audio content. Different sounds in spatial audio content, also referred to as sound components, are positioned at corresponding locations in a sound field that is centered with respect to a listener. The sound field represents a spatial relationship between the sound components and the listener. When the spatial audio content is played, each sound component sounds as if it were generated at the corresponding location with respect to the listener (e.g., as if the source of that sound component were positioned at the corresponding location). As spatial audio continues to gain popularity, there is a demand for spatial audio content which is engaging and pleasant to the listener. Spatial audio content which naturally integrates one or more voices may be of particular interest.

### SUMMARY

Embodiments described herein relate to spatial audio, and in particular to systems and methods for relocating a sound component in spatial audio content to improve user experience. In one embodiment, a method for relocating a sound component in a sound field of spatial audio content may include identifying a sound component for relocation. Identifying the sound component for relocation may include determining that the sound component is located within a center region in the sound field. The sound component may be separated from one or more non-central sound components in the spatial audio content. The sound component may be relocated to a location in the sound field outside the center region in the sound field. The relocated sound component may be integrated with the one or more non-central sound components to provide integrated spatial audio content.

In one embodiment, identifying the sound component for relocation may further include determining that the sound component corresponds to a voice. In particular, identifying the sound component for relocation may include determining that the sound component corresponds to a voice of a predetermined user. In another embodiment, identifying the sound component for relocation may further include matching one or more characteristics of the sound component to one or more predetermined criteria.

In one embodiment, the spatial audio content may be a binaural audio recording.

In one embodiment, the method further may include identifying an additional sound component for relocation. Identifying the additional sound component for relocation may include determining that the additional sound component is located within the center region in the sound field. The additional sound component may be separated from the sound component and the one or more non-central sound components, processed to relocate the additional sound component to an additional location in the sound field outside the center region of the sound field, and integrated with the sound component and the one or more non-central sound components to provide the integrated spatial audio content.

In one embodiment, the method may further include determining motion information about a user and causing an audio output device to output the integrated spatial audio content such that a sound field of the integrated spatial audio content is moved with respect to the user based on the movement information.

In one embodiment, an electronic device may include an audio output device and a processor communicably coupled to the audio output device. The processor may be configured to identify, in spatial audio content having a sound field, a sound component for relocation. Identifying the sound component for relocation may include determining that the sound component is located within a center region of the sound field. The processor may be further configured to isolate the sound component from one or more non-central sound components in the spatial audio content, process the sound component to relocate the sound component to a location outside the center region of the sound field, and output the relocated sound component and the one or more non-central sound components via the audio output device to a user.

In one embodiment, identifying the sound component for relocation may further include determining that the sound component corresponds to a voice. In particular, identifying the sound component for relocation may further include determining that the sound component corresponds to the voice of a particular user. In another embodiment, identifying the sound component for relocation may further include matching one or more characteristics of the sound component to one or more predetermined criteria.

In one embodiment, the spatial audio content may be a binaural audio recording.

In one embodiment, the processor may be further configured to identify an additional sound component for relocation. Identifying the additional sound component for relocation may include determining that the additional sound component is within the center region of the sound field. The processor may be further configured to isolate the additional sound component from the sound component and the one or more non-central sound components, process the additional sound component to relocate the additional sound component to an additional location in the sound field outside the center region in the sound field, and output the additional sound component via the audio output device to the user.

In one embodiment, the electronic device may further include a motion tracking system communicably coupled to the processor. The motion tracking system may be configured to determine motion information about the user. The processor may be further configured to output the relocated sound component and the non-central components via the audio output device such that the sound field is moved with respect to the user based on the movement information.

In one embodiment, the electronic device may be a head-mounted device. The electronic device may further include a camera communicably coupled to the processor. The processor may be further configured to identify a sound component output location in an image frame captured at the camera, and identify the location in the sound field outside the center region based on a relationship between the sound component output location and the sound field.

In one embodiment, a method for relocating a sound component in a sound field of spatial audio content includes identifying the sound component for relocation. Identifying the sound component for relocation may include determining that the sound component is located within a center region in the sound field. The sound component may be isolated from non-central sound components in the spatial audio content. The sound component may be processed to relocate the sound component to a location in the sound field outside the center region in the sound field. The relocated sound component may be outputted from an audio output device along with the non-central sound components.

In one embodiment, the method may further include determining motion information about a user and outputting the sound component and the non-central sound components at the audio output device such that the sound field is moved with respect to the user based on the motion information.

In one embodiment, the sound component may be processed based on the motion information such that the sound component is moved with respect to the user independently from the sound field.

In one embodiment, identifying the sound component for relocation further includes matching one or more characteristics of the sound component to one or more predetermined criteria.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a block diagram of an electronic device, such as described herein.

FIGS. 2A through 2C illustrate a sound field of spatial audio content, such as described herein.

FIG. 3 is a flow chart illustrating a method for relocating a sound component in spatial audio content, such as described herein.

The use of the same or similar reference numerals in different figures indicates similar, related, or identical items.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to spatially rendering audio, and in particular to systems and methods for relocating one or more sound components in a sound field of spatial audio content to improve user experience. As discussed herein, “spatial audio content” includes a sound recording in which one or more sound components are associated with corresponding locations within a sound field. The sound field represents the spatial environment surrounding a listener, such that when the spatial audio content is outputted via an audio output device, each sound component is rendered such that the listener perceives that the sound component is coming from its corresponding location within the sound field.

While spatial audio content has the potential to provide an immersive listening experience that better reflects a real world audio environment, the location of certain sound components in the sound field of spatial audio content may at times be disruptive or unpleasant to a listener. For example, a vocal sound component (i.e., the sound of a person's voice) located in close proximity to a listener within the sound field may sound uncomfortably close to a listener. In particular, a listener playing back spatial audio content including their own voice may perceive their voice as originating too close, or in some cases, inside their own head. This may be especially true if the spatial audio content was recorded from one or more microphones near the head or mouth of a person recording the spatial audio content during recording. Other scenarios, such as raindrops striking a recording device or an insect flying near the recording device while recording sounds may result in distracting sound components located in close proximity to a listener within the sound field. Systems and methods of the present disclosure may improve user experience when listening to spatial audio content by relocating one or more sound components within the sound field of the spatial audio content.

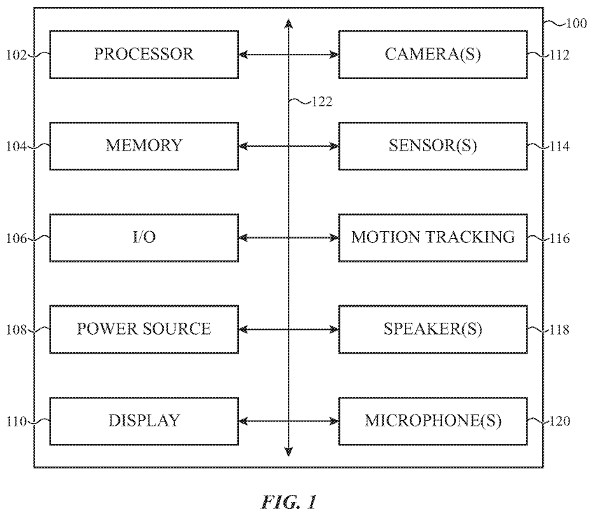

FIG. 1 is a block diagram illustrating an electronic device 100 for playing back and/or processing spatial audio content according to one embodiment of the present disclosure. The electronic device 100 may include a processor 102, a memory 104, an input/output (I/O) mechanism 106, a power source 108, a display 110, one or more cameras 112, one or more sensors 114, a motion tracking system 116, one or more speakers 118, and one or more microphones 120. The processor 102, the memory 104, the I/O mechanism 106, the power source 108, the display 110, the one or more cameras 112, the one or more sensors 114, the motion tracking system 116, the one or more speakers 118, and the one or more microphones 120 may be communicably coupled via a bus 122.

The processor 102 may be configured to execute instructions stored in the memory 104 in order to provide some or all of the functionality of the electronic device 100, such as the functionality discussed herein. The processor 102 may be implemented as any electronic device capable of processing, receiving, or transmitting data or instructions, whether such data or instructions is in the form of software or firmware or otherwise encoded. For example, the processor 102 may include a microprocessor, a central processing unit (CPU), an application-specific integrated circuit (ASIC), a digital signal processor (DSP), a controller, or a combination of such devices. As discussed herein, the term processor is meant to encompass a single processing unit, multiple processors, multiple processing units, or other suitably configured computing element or elements.

In some embodiments, the components of the electronic device 100 may be controlled by multiple processors. For example, select components of the electronic device 100 such as the one or more sensors 114 may be controlled by a first processor while other components of the electronic device 100 (e.g., the display 110) may be controlled by a second processor, where the first and second processor may or may not be in communication with each other.

The memory 104 may store electronic data that can be used by the electronic device 100. For example, the memory 104 may store instructions, which, when executed by the processor 102 provide the functionality of the electronic device 100 described herein. The memory 104 may further store electrical data or content such as, for example, audio and video files, documents and applications, device settings and user preferences, timing signals, control signals, and data structures and databases. The memory 104 may include any type of memory. By way of example only, the memory 104 may include random access memory (RAM), read-only memory (ROM), flash memory, removeable memory, and/or other types of storage elements, or a combination of such memory types.

The I/O mechanism 106 may transmit or receive data from a user or another electronic device. The I/O mechanism 106 may include the display 110, a touch sensing input surface, one or more buttons, the one or more cameras 112, the one or more speakers 118, the one or more microphones 120, one or more ports, a keyboard, or the like. Additionally or alternatively, the I/O mechanism 106 may transmit electronic signals via a communications interface, such as a wireless, wired, and/or optical communications interface. Examples of wireless and wired communications interfaces include, but are not limited to, cellular and Wi-Fi communications interfaces.

The power source 108 may be any device capable of providing energy to the electronic device 100. For example, the power source 108 may include one or more batteries or rechargeable batteries. Additionally or alternatively, the power source 108 may include a power connector or power cord that connects the electronic device 100 to another power source, such as a wall outlet.

The display 110 may provide a user interface to a user of the electronic device 100. In some embodiments, the display 110 may show a portion of an extended reality environment to a user. As discussed herein, an extended reality environment refers to a computer generated environment, which may be presented to a user as a completely virtual environment (e.g., virtual reality) or as one or more virtual elements that enhance or alter one or more real world objects (e.g., augmented reality and/or mixed reality). The display 110 may be a single display or include two or more displays. For example, the display 110 may include a display for each eye of a user. The display 110 may include any type of display, including a liquid crystal display (LCD), an organic light-emitting diode (OLED) display, or any other type of display.

The one or more cameras 112 may be positioned and oriented on the electronic device 100 to capture images of an environment in which the electronic device 100 is located. In some embodiments, these images may be used to provide an extended reality experience to a user. The one or more cameras 112 may be any suitable type of camera. In various embodiments, the electronic device 100 may include one, two, four, or any number of cameras. In some embodiments, some of the one or more cameras 112 may be positioned and oriented on the electronic device 100 to capture images of the user. For example, these images may be used to track a portion of the user's body, such as their eyes, mouth, cheek, arms, torso, or legs.

The one or more sensors 114 may capture additional information about the environment in which the electronic device 100 is located and/or a user of the electronic device 100. The one or more sensors 114 may be configured to sense one or more types of parameters, including but not limited to: vibration, light, touch, force, temperature, movement, relative motion, biometric data (e.g., biological parameters of a user), air quality, proximity, position, or connectedness. By way of example, the one or more sensors 114 may include one or more optical sensors, a temperature sensor, a position sensor, an accelerometer, a pressure sensor, a gyroscope, a health monitoring sensor, and/or an air quality sensor. Additionally, the one or more sensors 114 may utilize any suitable sensing technology including, but not limited to, interferometric, magnetic, capacitive, ultrasonic, resistive, optical, acoustic, piezoelectric, or thermal technologies.

The motion tracking system 116 may provide motion tracking information about the electronic device 100. For example, the motion tracking system 116 may provide a position and orientation of the electronic device 100 that is either absolute or relative. The motion tracking system 116 may utilize any of the one or more sensors 114 to do so, or may include separate sensors for providing the motion tracking information. The motion tracking system 116 may also utilize any of the one or more cameras 112 for providing the motion tracking information, or may include one or more separate cameras for doing so.

The one or more speakers 118 may be configured to output sounds to a user of the electronic device 100. The one or more speakers 118 may be any type of speakers in any form factor. For example, the one or more speakers 118 may be integrated into a headphones, earphones, bone conducting speakers, extra-aural speakers, or the like. Further, the one or more speakers 118 may be configured to playback binaural audio to the user. The one or more microphones 120 may be positioned and oriented on the electronic device 100 to sense sound provided from the surrounding environment and/or the user. The one or more microphones 120 may be any suitable type of microphones, and may be configured to enable the electronic device 100 to record binaural sound.

The electronic device 100 may be a head mounted device capable of displaying an extended reality environment (e.g., an augmented reality, mixed reality and/or virtual reality environment). Accordingly, the electronic device 100 may include a housing configured to be provided on or over a portion of a face of a user, and one or more straps or supports for holding the electronic device 100 in place when worn by the user. However, the principles of the present disclosure apply to electronic devices having any form factor. For example, the electronic device 100 may also be an audio playback device such as a pair of headphones. Notably, the components of the electronic device 100 described for purposes of illustration only. The principles of the present disclosure apply equally to an electronic device 100 including any subset of the components shown in FIG. 1, as well as any additional components.

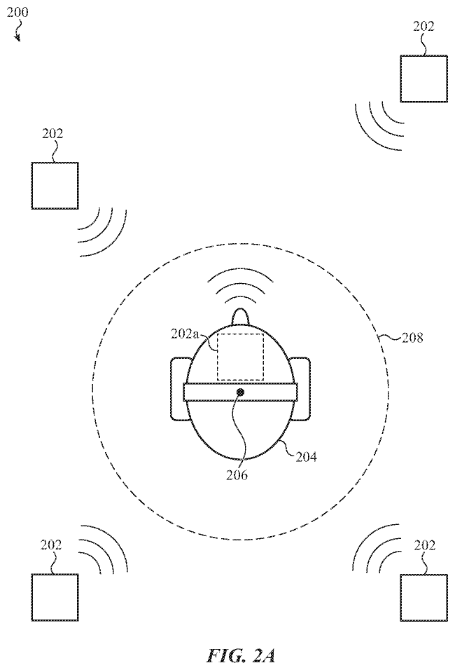

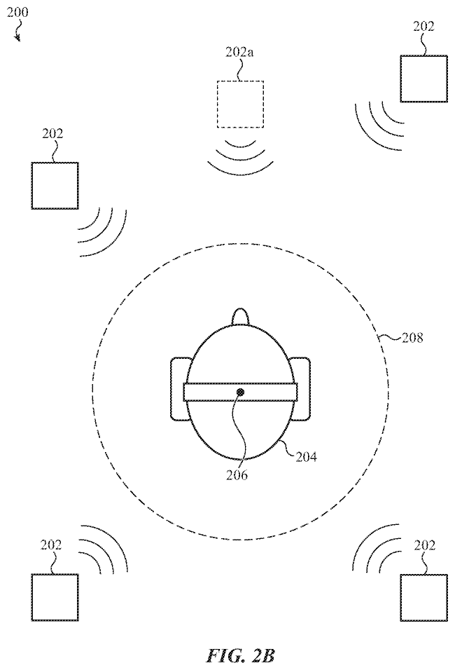

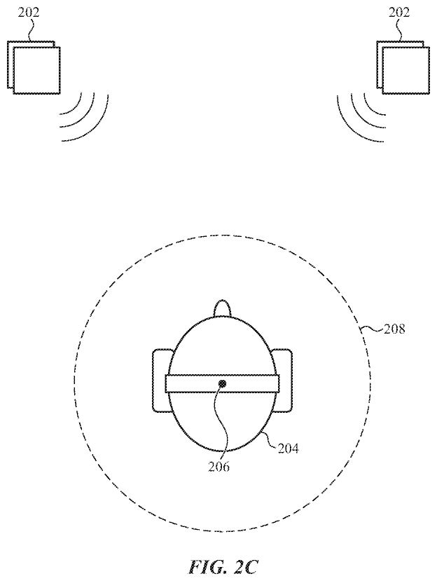

FIG. 2A shows a graphical representation of a sound field 200 associated with spatial audio content. A number of sound components 202 are shown at different locations in the sound field 200 with respect to a listener 204. As discussed herein, each of the sound components 202 are processed such that they sound from the listener's 204 perspective as if they are originating from their respective locations in the sound field 200. The sound field 200 may include a center 206, such that the positions of the various sound components 202 are positioned relative to the center 206. The center 206 of the sound field 200 may correspond to a position of the listener 204 in the sound field 200, such that when the sound components 202 are presented to the listener 204 (i.e., played back), the listener 204 perceives the sound components 202 as if they are located at the center 206 of the sound field 200. Notably, the center 206 of the sound field 200 may not be the same as the location from which the sound components 202 were recorded in some embodiments. The sound field 200 may also include a center region 208, which represents a portion of the sound field 200 located a predetermined distance from the center 206. The center region 208 may be used herein as a threshold for determining whether to relocate a given sound component 202. The area of the center region 208 may vary in different embodiments, and may represent any distance from the center 206. In some embodiments, a system may vary the area represented by the center region 208 for different types of sound components 202, or based on user preferences. In some instances, the listener 204 may find sound components 202 located within the center region 208 to be distracting or otherwise undesirable. To illustrate this, FIG. 2A shows a sound component 202a located within the center region 208. The sound components 202 outside of the center region 208 may be referred to as non-central sound components 202. The sound component 202a located within the center region 208 may sound to the listener 204 as if it is uncomfortably close, and thereby prove distracting or otherwise undesirable. This may be particularly true when the sound component 202a is a voice, and especially when the sound component 202a is the voice of the listener 204.

Spatial audio content may be recorded by an individual using one or more microphones attached to or otherwise close to the recording individual's head. For example, spatial audio content may be recorded by one or more microphones 120 in an electronic device 100 as described in FIG. 1, which may be in the form of a head-mounted device suitable for extended reality interaction or an audio output device such as headphones. In such an example, the recording individual's voice may be located within the center region 208 in the sound field 200. This may be distracting to the listener 204, as it may sound as if the voice of the recording individual is uncomfortably close to the listener 204. This may be especially true when the listener 204 is the recording individual, as it may sound like the listener's 204 own voice is too close. Other sounds within the center region 208, such as rain noise, noise from an insect passing nearby, etc. may also be distracting or otherwise unpleasant to the listener 204.

In an effort to reduce the impact of sound components 202 within the center region 208 on the listener 204, one or more sound components 202 within the center region 208 may be identified and relocated to a location in the sound field 200 outside the center region 208. FIG. 2B illustrates this process, as it shows the sound component 202a previously located within the center region 208 being relocated outside the center region 208 in front of the listener 204. While not shown, multiple sound components 202 may be identified in the center region 208 and relocated to a location in the sound field 200 outside the center region 208. To accomplish this, a sound component 202 may be determined to be located within the center region 208, the identified sound component 202 may be separated from other sound components 202, the identified sound component 202 may be processed to relocate the sound component 202 to the location outside the center region 208, and the relocated sound component 202 may be integrated with or otherwise combined with the other sound components 202 for playback. Details regarding the identification and relocation of sound components 202 in the center region 208 are discussed below. By relocating sound components 202 within the center region 208 outside the center region 208, the listening experience of the spatial audio content may be improved.

In some situations, it may be difficult to identify and relocate individual sound components 202 in spatial audio content. For example. recording quality and/or background noise may make it difficult to identify distinct sound components 202 and/or identify a location of the sound components 202 in the sound field 200 (e.g., to detect that a particular sound component 202 is within the center region 208). In other situations, a system may not have the resources available for identifying and relocating individual sound components 202 as discussed herein. This may occur, for example, when a user has requested playback of spatial audio content before the system has had a chance to fully analyze the content and/or generate a sound field 200 associated with the content. In such embodiments, all of the sound components 202 may be processed such that they are relocated to one or more predetermined locations in the sound field 200 with respect to the listener 204 that are outside the center region 208. In the example shown in FIG. 2C, all of the sound components 202 are relocated to stereo locations in front of the listener 204. Relocating all of the sound components 202 to one or more predetermined locations may remove the impact of sound components 202 within the center region 208 on the listener 204, even for challenging spatial audio content and/or when resources are not available for identifying and relocating individual sound components 202. In various embodiments, a system may select between the relocation of individual sound components 202 within the center region 208 as discussed with respect to FIG. 2B and the relocation of all sound components 202 to one or more predetermined locations as discussed with respect to FIG. 2C based on some criteria, such as based on the spatial audio content for playback (e.g., based on an assessment of the difficulty associated with identifying and relocating individual sound components 202 therein), and/or based on available resources at a system.

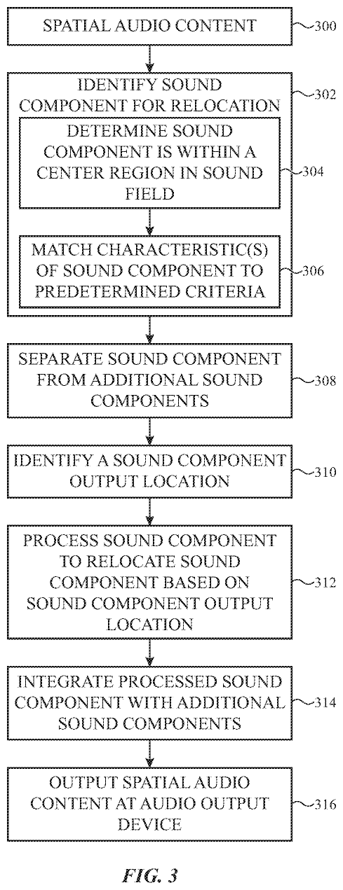

FIG. 3 is a flow chart illustrating a method for relocating a sound component within a sound field of spatial audio content according to one embodiment of the present disclosure. To start, the spatial audio content is received or accessed (block 300). Receiving or accessing the spatial audio content may include, for example, retrieving the spatial audio content from a memory or storage device or receiving the spatial audio content via a network communications interface. As discussed herein, the spatial audio content includes a sound field in which one or more sound components are placed. A sound component in the spatial audio content may then be identified for relocation (block 302). In some embodiments, identifying the sound component for relocation includes one or more of determining that the sound component is at a center region in the sound field (block 304) and, optionally, matching one or more characteristics of the sound component to one or more predetermined criteria (block 306). As discussed above, the center region may be defined as an area within a predefined distance of a center of the sound field. The one or more characteristics of the sound component may include a type of the sound component (e.g., a voice, a siren), content of the sound component (e.g., tones, frequencies), a volume of the sound component, the location of the sound component within the center region of the sound field, or any other characteristics. Notably, blocks 304 and 306 represent exemplary ways to identify a sound component for relocation in a sound field, and the present disclosure contemplates the use of additional or alternative steps for accomplishing the same.

The identified sound component may then be separated from other (e.g., non-central) sound components in the spatial audio content (block 308). In some embodiments, each sound component in the spatial audio content may comprise a separate data stream, and thus separating the sound component may simply include referencing the separate data stream of the sound component. In other embodiments, one or more sound components may be part of a single data stream and thus additional processing may be necessary to separate the identified sound component from the non-central sound components. Those skilled in the art will readily appreciate how to separate a sound component from other sound components in audio content, and thus further details of this step are omitted.

Optionally, a sound component output location may be identified (block 310). In some embodiments, the sound component output location may be predefined, and thus this step may be skipped. In other embodiments, the sound component output location may be determined based on any number of criteria, including, for example, one or more characteristics of the environment in which the listener is located (e.g., determined by sensor data from one or more sensors in an electronic device playing back the spatial audio content) and one or more characteristics of the spatial audio recording itself (e.g., the location of sound components in the sound field, content of the spatial audio recording, etc.). In one example, the sound component output location may be based on the identified sound component itself. For example, if the identified sound component is determined to be a voice, it may be relocated to a first predetermined location outside the center region of the sound field. If the identified sound component is identified to be an insect, it may be relocated to a second predetermined location outside the center region of the sound field, which is different from the first predetermined location. The second predetermined location may be based on the original location of the sound component.

In one embodiment, the sound component output location may be determined based on one or more images captured of the environment in which the listener is located. The one or more images may be captured by one or more cameras on an electronic device playing back the spatial audio content. The sound component output location may be identified in the one or more images (e.g., based on one or more objects in the images, one or more surfaces in the images, etc.).

The sound component may be processed to relocate the sound component in the sound field based on the sound component output location (block 312). In one embodiment, a relationship between the sound component output location and the sound field (e.g., a known or determined spatial relationship between the sound component output location and the sound field) may be used to relocate the sound component in the sound field. Any suitable processing techniques may be used to relocate the sound component in the sound field. Those skilled in the art will readily appreciate processing techniques for relocating a sound component to a different location in a sound field, and thus the details of this step are omitted.

Optionally, the relocated sound component may be integrated with the non-central sound components to provide integrated spatial audio content (block 314). Notably, this block may include generating new spatial audio content wherein the sound component is relocated in the sound field, and thus may be performed when it is desirable to persist or store the integrated spatial audio content. In some embodiments, this block may be skipped, and the relocated sound component may simply be outputted along with the additional sound components via an audio output device such as one or more speakers (block 316). However, block 316 may also include playing back the integrated spatial audio content generated in block 314. In other words, the relocated sound component and additional sound components may be integrated to provide integrated spatial audio content that can be stored for later playback or streamed directly to an audio output device as separate audio streams.

In one embodiment, motion information about a listener of the spatial audio content may be used to output the spatial audio content such that the sound field moves with respect to the user based on the motion information. That is, motion information about the listener may be used to simulate the sound components in the sound field remaining at a particular location as the listener moves his or her head. This may enhance immersion in the spatial audio content, thus improving user experience.

Blocks 300-316 may be performed for any number of sound components. That is, any number of sound components may be identified for relocation and subsequently relocated according to the processes described herein.

The blocks of the method may be performed, for example, by the electronic device 100 described in FIG. 1, which may be worn by a listener. In various embodiments, a number of the blocks of the method may be performed by one or more processing resources located in one or more remote devices (e.g., instantiated by hardware in one or more servers), with the remaining steps being performed by the electronic device 100. For example, identifying the sound component for relocation, isolating the sound component, and processing the sound component may be performed by one or more processing resources located in one or more remote devices, while the remaining steps may be performed by the electronic device 100.

These foregoing embodiments depicted in FIGS. 1-3 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

What is claimed is:

1. A method for relocating a sound component in a sound field of spatial audio content, comprising:
identifying the sound component for relocation, comprising determining that the sound component is located within a center region in the sound field;
separating the sound component from one or more non-central sound components in the spatial audio content;
processing the sound component to relocate the sound component to a location in the sound field outside the center region in the sound field; and
integrating the relocated sound component with the one or more non-central sound components to provide integrated spatial audio content.

2. The method of claim 1, wherein identifying the sound component for relocation further comprises determining that the sound component corresponds to a voice.

3. The method claim 1, wherein identifying the sound component for relocation further comprises determining that the sound component is a voice of a predetermined user.

4. The method of claim 1-3, wherein identifying the sound component for relocation further comprises matching one or more characteristics of the sound component to one or more predetermined criteria.

5. The method of claim 1, wherein the spatial audio content is a binaural audio recording.

6. The method of claim 1, further comprising:
identifying an additional sound component for relocation, comprising determining that the additional sound component is located within the center region in the sound field;
separating the additional sound component from the sound component and the one or more non-central sound components;
processing the additional sound component to relocate the additional sound component to an additional location in the sound field outside the center region in the sound field; and
integrating the additional sound component with the sound component and the one or more non-central sound components to provide the integrated spatial audio content.

7. The method of claim 1, further comprising:
determining motion information about a user; and
causing an audio output device to output the integrated spatial audio content such that a sound field of the integrated audio recording is moved with respect to the user based on the movement information.

8. The method of claim 1, wherein the location in the sound field outside the center region is in front of a center location in the sound field.

9. An electronic device, comprising:
an audio output device; and
a processor communicably coupled to the audio output device and configured to:
identify, in spatial audio content having a sound field, a sound component for relocation, comprising determining that the sound component is located within a center region of the sound field;
separating the sound component from one or more non-central sound components in the spatial audio content;
processing the sound component to relocate the sound component to a location outside the center region in the sound field; and
output the relocated sound component and the one or more non-central sound components via the audio output device to a user.

10. The electronic device of claim 9, wherein identifying the sound component for relocation further comprises determining that the sound component corresponds to a voice.

11. The electronic device of claim 9, wherein identifying the sound component for relocation further comprises determining that the sound component corresponds to the voice of a predetermined user.

12. The electronic device of claim 9, wherein identifying the sound component for relocation further comprises matching one or more characteristics of the sound component to one or more predetermined criteria.

13. The electronic device of claim 9, wherein the spatial audio content is a binaural audio recording.

14. The electronic device of claim 9, wherein the processor is further configured to:
identify an additional sound component for relocation, comprising determining that the additional sound component is located within the center region in the sound field;
separate the additional sound component from the sound component and the one or more non-central sound components;
process the additional sound component to relocate the additional sound component to an additional location in the sound field outside the center region in the sound field; and
output the additional sound component via the audio output device to the user.

15. The electronic device of claim 9, further comprising motion tracking circuitry communicably coupled to the processor and configured to determine motion information about the user, wherein the processor is further configured output the relocated sound component and the non-central sound components via the audio output device such that the sound field is moved with respect to the user based on the movement information.

16. The electronic device of claim 9, wherein the electronic device is a head-mounted device.

17. The electronic device of claim 9, further comprising a camera communicably coupled to the processor, wherein the processor is further configured to:
identify a sound component output location in an image frame captured from the camera; and
identify the location in the sound field outside the center region in the sound field based on a relationship between the sound component output location and the sound field.

18. A method for relocating a sound component in a sound field of spatial audio content, comprising:
identifying the sound component for relocation, comprising determining that the sound component is located within a center region in the sound field;
separating the sound component from non-central sound components in the spatial audio content;
processing the sound component to relocate the sound component to a location in the sound field outside the center region in the sound field; and
outputting the relocated sound component and the non-central sound components via an audio output device.

19. The method of claim 18, further comprising:
determining motion information about a user; and
outputting the sound component and the non-central sound components via the audio output device such that the sound field is moved with respect to the user based on the motion information.

20. The method of claim 19, further comprising processing the sound component based on the motion information such that the sound component is moved with respect to the user independently from the sound field.
